(19) United States
(12) Patent Application Publication
(10) Pub. No.: US 2016/0108994 A1
(43) Pub. Date: Apr. 21, 2016

(54) TRANSMISSION WITH REVERSE GEAR BRAKE

(71) Applicant: GM Global Technology Operations LLC, Detroit, MI (US)

(72) Inventors: EDMAR JOSE PEREIRA GOMES, Sao Jose Dos Campos (BR); ROGERIO MARTINS FERNANDES, Sao Bernardo do Campo (BR); RICARDO FURQUIM, Santo Andre (BR); LEANDRO FRANCISCO ABREU, Sao Paulo (BR)

(21) Appl. No.: 14/849,121

(22) Filed: Sep. 9, 2015

Related U.S. Application Data
(60) Provisional application No. 62/066,032, filed on Oct. 20, 2014.

(51) Int. Cl. F16H 3/32; F16H 3/38

(52) U.S. Cl. CPC F16H 3/32; F16H 3/38; F16H 2200/0043

(57) ABSTRACT

A manual transmission is provided having a plurality of planar gear sets for achieving multiple forward gear ratios. The transmission also has an idler gear, a first planar gear set, a first shift linkage member, and an intermediate linkage member. The first shift linkage member has a synchronizer portion and a fork portion. The intermediate linkage member has a partial engagement cam portion that contacts and urges the fork portion of the shift linkage member to partially engage the synchronizer and the output member with the third gear prior to shifting the idler gear to mesh the input shaft with the output shaft.

### CROSS-REFERENCE TO RELATED APPLICATIONS

This application claims priority to Provisional U.S. Application No. 62/066,032 filed Oct. 20, 2014. The disclosure of the above application is incorporated herein by reference.

### FIELD

The present disclosure relates generally to transmissions and more specifically to manual transmissions having an idler gear brake employed to reduce gear clash when shifting into a reverse gear ratio.

### BACKGROUND

The statements in this section merely provide background information related to the present disclosure and may or may not constitute prior art.

A typical manual transmission includes a plurality of shafts, gears, shift mechanisms, synchronizers or other torque-transmitting mechanisms that cooperate to provide a plurality of forward and reverse gear or speed ratios. The transmission input shaft is selectively connected to an engine output shaft and includes a number of gears that are selectively connectable to the input shaft using, for example, synchronizers. The gears of the input shaft mesh with corresponding gears that are selectively connectable to an output shaft. To achieve a particular forward gear ratio between the transmission input and output shafts, the driver operates a shift mechanism, such as a manual shifter, that controls the engagement of the synchronizers with the desired gears. To achieve a reverse gear ratio, an idler gear is used to slide between an input shaft gear and an output shaft gear to reverse the rotational direction of the output shaft, and thus the drive wheels.

The idler gear is free to rotate on an idler gear shaft and the idler gear is not necessarily rotating when the idler gear is engaged to the input shaft reverse gear. However, the input shaft is often rotating at a high speed having only recently been disengaged from the engine output shaft. Once the idler gear is meshing with the input shaft reverse gear they will both be rotating at the same high speed. The idler gear must then engage the output shaft gear to complete the torque transfer to the output shaft. However, as often is the case, the output shaft is not rotating and may even be rotating in the opposite direction as the driver may be shifting into reverse before the vehicle has stopped moving forward. The meshing of the fast rotating idler gear with a stationary output gear causes an impact or gear clash that creates noise and grinding that is very objectionable to the driver. Furthermore, gear clash is detrimental to the long term durability of the transmission and is the source of costly customer repair bills.

Accordingly, there is room in the art for a transmission that includes a mechanism to reduce or eliminate gear clash and premature component wear by reducing the input shaft and idler gear rotational speed when the driver is shifting into a reverse gear ratio.

### SUMMARY

A transmission having a plurality of forward gear ratios and at least one reverse gear ratio is provided. The transmission includes an input and output member, an idler gear, a planar gear set, a first shift linkage member, and an intermediate linkage member. The input member is selectively connected to an engine output. The output member is connected to a vehicle drive shaft. The idler gear rotatably is supported by an idler member. The idler gear is selectively translated axially to mesh with each of a first gear and a second gear. The first gear is fixed for common rotation with the input member. The second gear is fixed for common rotation with the output member to achieve the reverse gear ratio between the input and output members.

The planar gear set has a third gear in mesh with a fourth gear. The third gear is rotatably supported by the output member and the fourth gear coupled for common rotation with the input member. The third gear is selectively coupled to the output member through axial movement of a synchronizer to achieve one of the plurality of forward gear ratios between the input and output members.

The first shift linkage member has a synchronizer portion and a fork portion. The synchronizer portion is engaged for common axial movement with the synchronizer.

The intermediate linkage member has a shift linkage portion, a reverse idler gear portion, and a partial engagement cam portion. The intermediate linkage member is selectively translated in an axial direction and a rotational direction.

The partial engagement cam portion of the intermediate linkage member contacts and urges the fork portion of the shift linkage member to partially engage the synchronizer and the output member with the third gear.

In another example of the present invention, the cam portion of the intermediate linkage member contacts the fork portion of the shift linkage member prior to the reverse idler gear portion of the intermediate linkage member rotates and engages the idler member to mesh the reverse idler gear with the first and second gears.

In yet another example of the present invention, the planar gear set achieves an intermediate gear ratio when the third gear is engaged for common rotation with the input member.

In yet another example of the present invention, the planar gear set achieves one of a third and fourth gear ratio when the third gear is engaged for common rotation with the input member.

In yet another example of the present invention, the shift linkage includes a cam contact portion that extends from the fork portion to contact the cam portion of the intermediate linkage member.

In yet another example of the present invention, the cam contact portion includes a resilient ball mechanism to contact the cam portion of the intermediate linkage member.

In yet another example of the present invention, the cam portion of the intermediate linkage member includes a partial engagement profile that prevents synchronizer clash with the third gear.

In yet another example of the present invention, the transmission includes a second shift linkage member having an idler gear fork and an elongated member. The idler gear fork is engaged for common axial movement with the idler gear. The elongated member is fixed to the idler gear fork. The elongated member includes a notch that is selectively engaged by the reverse idler gear portion of the intermediate linkage member.

Further objects, aspects and advantages of the present disclosure will become apparent by reference to the following description and appended drawings wherein like reference numbers refer to the same component, element or feature.

### DRAWINGS

The drawings described herein are for illustration purposes only and are not intended to limit the scope of the present disclosure in any way.

FIG. 1 is a perspective view of a transmission according to the present disclosure;

FIG. 2 is plan view of a shift fork and intermediate shaft assembly according to the present disclosure;

FIG. 3 is a detailed plan view of a shift fork and intermediate lever assembly according to the present disclosure;

FIG. 4 is a perspective view of a shift fork and intermediate shaft assembly according to the present disclosure;

FIG. 5 is a close-up perspective view of a shift fork assembly according to the present disclosure;

FIG. 6A is a plan view of a shift fork and intermediate lever assembly in a first position according to the present disclosure;

FIG. 6B is a plan view of a shift fork and intermediate lever assembly in a second position according to the present disclosure;

FIG. 6C is a plan view of a shift fork and intermediate lever assembly in a third position according to the present disclosure; and

FIG. 6D is a plan view of a shift fork and intermediate lever assembly in a fourth position according to the present disclosure.

### DETAILED DESCRIPTION

The following description is merely exemplary in nature and is not intended to limit the present disclosure, application, or uses.

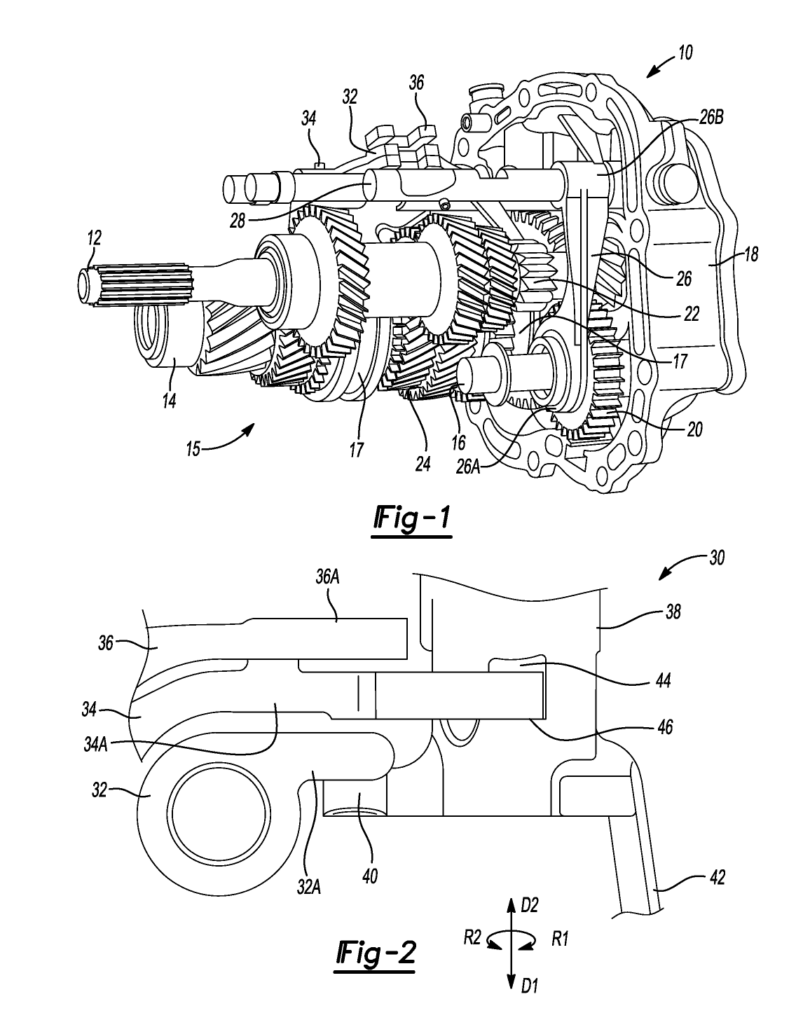

Referring to the drawings, wherein like reference numbers refer to like components, in FIG. 1 a perspective view of a partial transmission 10 of the present invention is illustrated. The transmission 10 includes an input shaft 12, a main shaft or output shaft 14 and an idler shaft 16 each supported by a housing 18. The input shaft 12 is connected to, for example, an engine output shaft (not shown) and the main shaft 14 is connected to, for example, a vehicle drive shaft (not shown) that provides torque to a drive wheel of the vehicle. The input and main shafts 12, 14 rotatably support a plurality of gears that intermesh to form a plurality of gear sets 15. A plurality of sleeves and synchronizers 17 is selectively manipulated to achieve a desired forward gear ratio between the input shaft 12 and the main shaft 14. For example, to achieve a forward gear ratio, one of the plurality of sleeves and synchronizers 17 is engaged to couple a gear from one of the gear sets 15 to one of the input shaft 12 and the main shaft 14 in order to transfer torque from the input shaft 12 to the main shaft 14.

The idler shaft 16 is fixed securely with the housing 18 and supports an idler gear assembly 20. The idler gear assembly 20 is capable of selective movement along the idler shaft 16 to engage a reverse gear or member 22 of the input shaft 12 and a sleeve gear or member 24 on the main shaft 14. When a reverse gear ratio is desired, the idler gear assembly 20 meshes independently with the reverse gear 22 that is engaged with the input shaft 12 and the sleeve gear 24 that is engaged with the main shaft 14. The engaged idler gear assembly 20 reverses the direction of the sleeve gear 24 of the main shaft 14 and therefore reverses the direction of rotation of the drive shaft of the vehicle. For example, the idler gear assembly 20 is manipulated by a shift fork linkage 26 that includes a first end 26A secured to a reverse shaft or member 28 and a second end 26B that engages and moves the idler gear assembly 20 axially along the idler shaft 16. However, other methods or mechanisms of manipulating the idler gear assembly 20 may be employed without departing from the scope of the present invention.

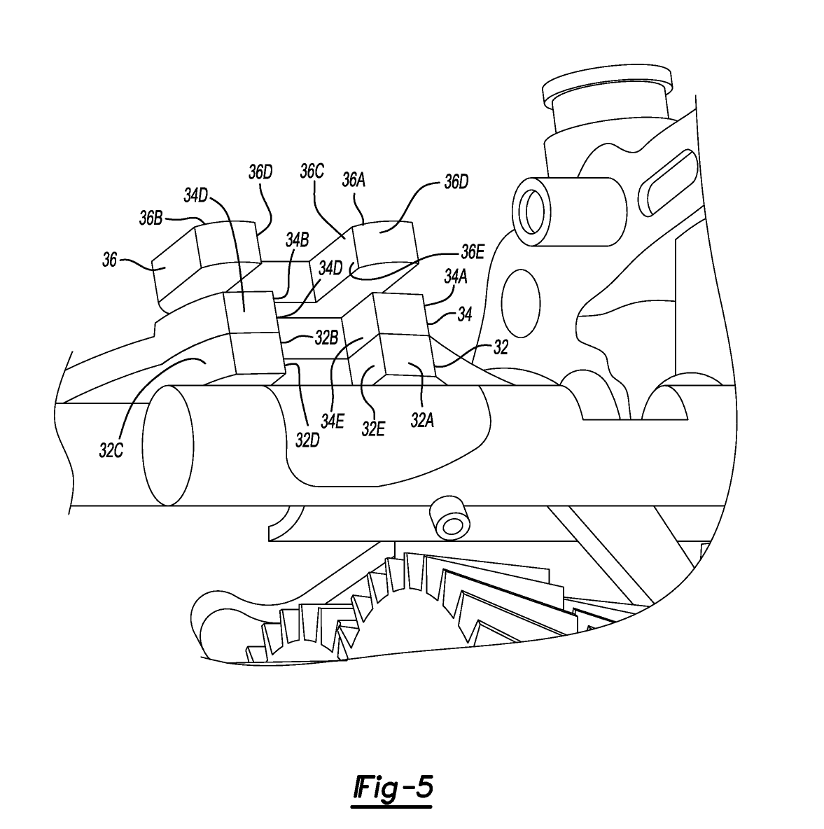

Referring now to FIGS. 2 and 5 with continuing reference to FIG. 1, an example of a shift fork and intermediate lever assembly is illustrated and will now be described. For example, the shift fork and intermediate lever assembly 30 is shown fully in FIG. 2 and partially in FIG. 1. The assembly 30 includes a first and second gear shift fork 32, a third and fourth gear shift fork 34, a fifth and sixth gear shift fork 36, and an intermediate lever 38 (shown in FIG. 2). The intermediate lever 38 includes a shift fork actuator portion 40, a reverse idler gear actuator portion 42, and a partial engagement cam 44 and is capable of axial movement in a first and second direction D1, D2 and rotational movement in a first and second rotational direction R1, R2. The partial engagement cam 44 has a profile shape including ramping portions 44A and an engagement portion 44B. Each of the shift forks 32, 34, 36 include a fork portion 32A, 34A, 36A having a first and second finger or prong 32B, 32C, 34B, 34C, 36B, 36C extending from the fork portion. Each first finger 32B, 34B, 36B has a gear surface 32D, 34D, 36D for individually engaging the shift fork actuator portion 40 of the intermediate lever 38 when the intermediate lever is rotated in the first rotational direction R1. Each second finger 32C, 34C, 36C has a gear surface 32E, 34E, 36E opposite the gear surface 32D, 34D, 36D of the first finger 32B, 34B, 36B, respectively, for individually engaging the shift fork actuator portion 40 of the intermediate lever 38 when the intermediate lever is rotated in the second rotational direction R2. For example, the fork portion 32A of the first and second shift fork 32 includes a first finger 32B having a first gear surface 32C and a second finger 32D having a second gear surface 32E opposing the first gear surface 32C. The fork portion 34A of the third and fourth shift fork 34 includes a first finger 34B having a third gear surface 34C and a second finger 34D having a fourth gear surface 32E opposing the third gear surface 34C. The fork portion 36A of the fifth and sixth shift fork 36 includes a first finger 36B having a fifth gear surface 36C and a second finger 36D having a sixth gear surface 36E opposing the fifth gear surface 34C. As the intermediate lever is manipulated in the first and second directions D1, D2 the shift fork actuator portion 40 passes between the gear surfaces 32D, 3E, 34D, 34E, 36D, 36E until the shift fork actuator portion 40 arrives at the desired gear shift fork 32, 34, 36. The lever is then manipulated in the first or second rotational direction R1, R2 depending on the desired gear ratio and the shift fork actuator portion 40 is subsequently rotated into the desired gear surface 32D, 3E, 34D, 34E, 36D, 36E engaging the desired shift fork 32, 34, 36 and thus synchronizing the desired gear with the output shaft 14.

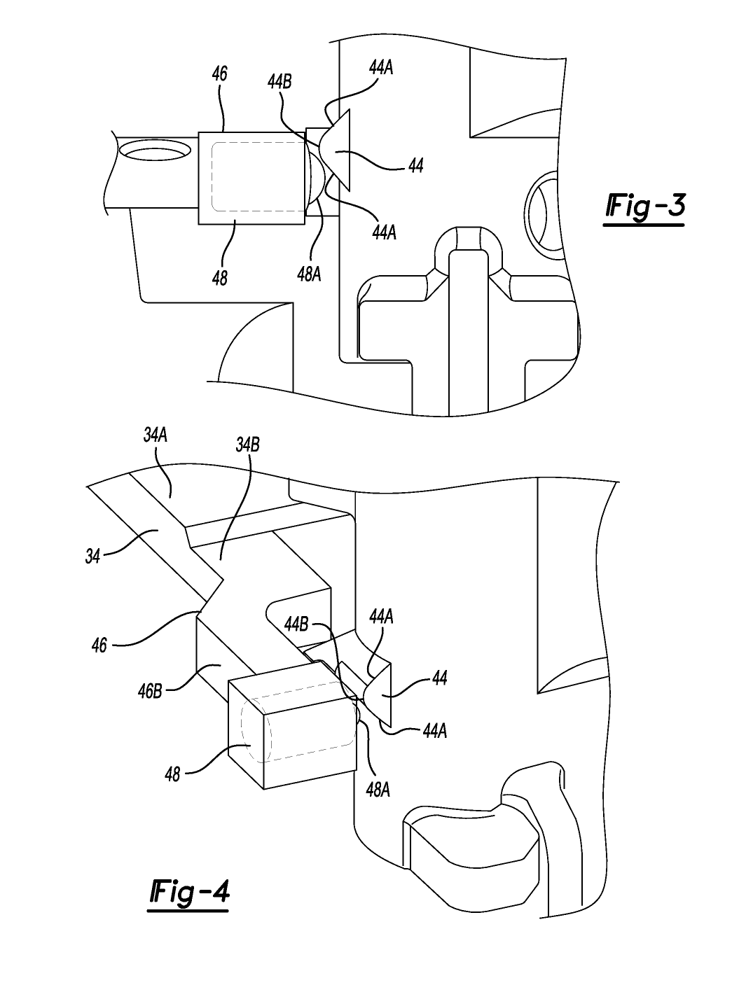

Referring now to FIGS. 3 and 4 with continued reference to FIG. 2, the third and fourth gear shift fork 34 also includes a partial engagement lever 46 extending from the first finger 34B of the fork portion 34A. The partial engagement lever 46 has a first end 46A fixedly attached to the first finger 34B and a cam follower portion 48 disposed on a second end 46B. The cam follower portion 48 opposes the partial engagement cam 44 when the partial engagement cam is in a neutral position or not rotated in either the first or second rotational directions R1, R2. The cam follower portion 48 includes a spring loaded ball 48A that follows the profile of the partial engagement cam 44 when the intermediate lever 38 translates in the first and second directions D1, D2.

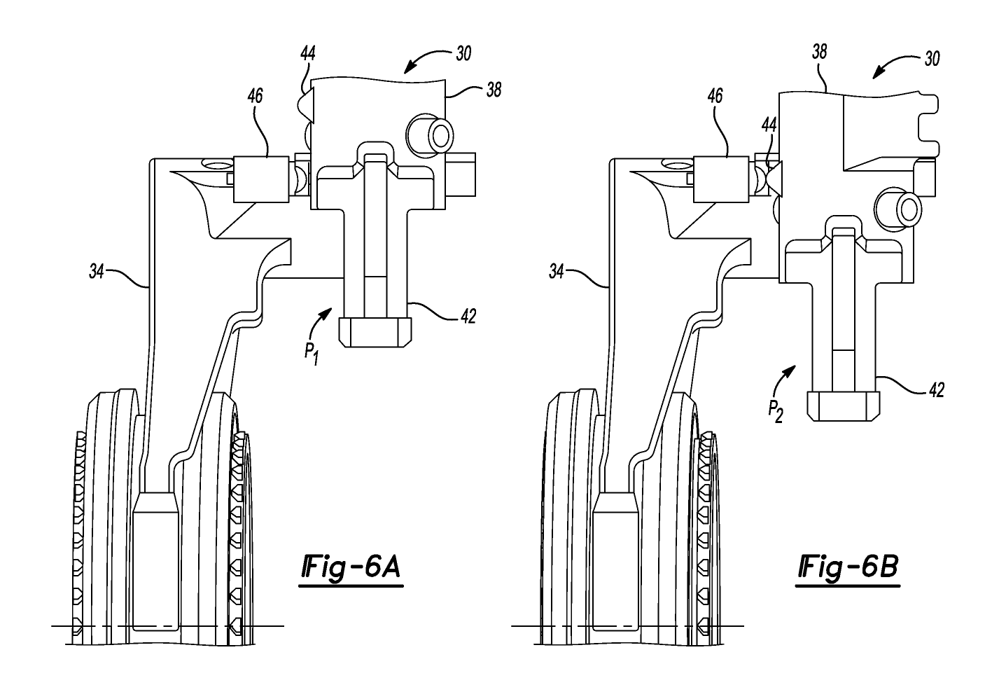

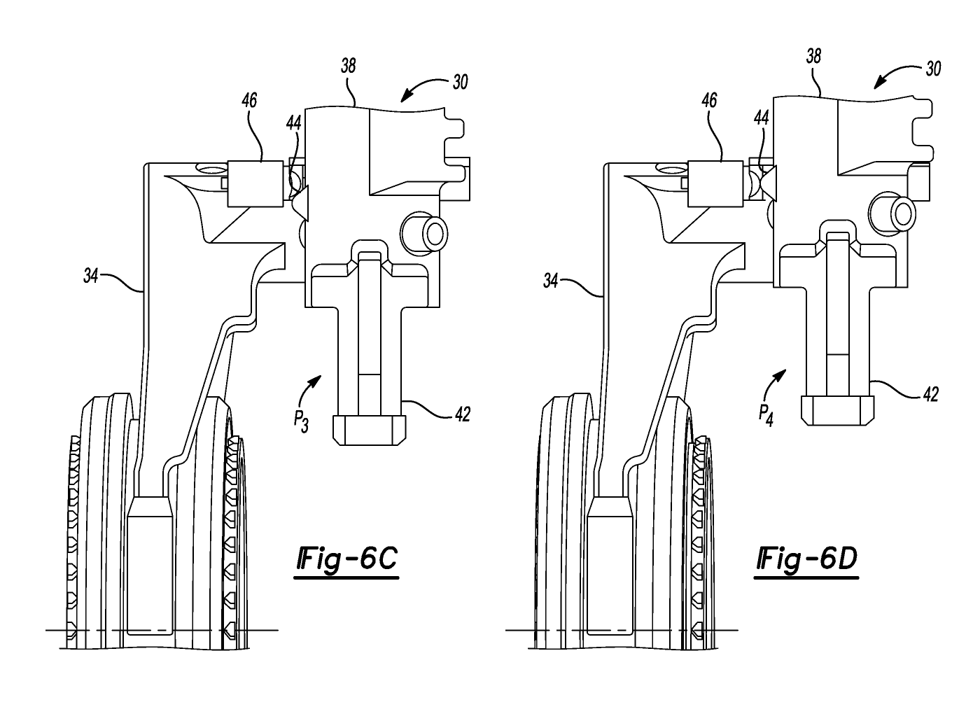

Referring now to FIGS. 6A-6D with continuing reference to FIGS. 2-4, the intermediate lever 38 and third and fourth gear shift fork 34 is illustrated and will now be described. The intermediate lever 38 is capable of being moved to each of four positions. In a first position P1, the intermediate lever 38 is manipulated so that the shift fork actuator portion 40 is disposed between the fifth gear and sixth gear surfaces 36D, 36E of the fifth and sixth gear fork 36. In a second position P2, the intermediate lever 38 is manipulated so that the shift fork actuator portion 40 is disposed between the third gear and fourth gear surfaces 34D, 34E of the third and fourth gear fork 34. In a third position P3, the intermediate lever 38 is manipulated so that the shift fork actuator portion 40 is disposed between the first gear and second gear surfaces 32D, 32E of the first and second gear fork 34. In a fourth position P4, the cam follower portion 48 of the third and fourth gear shift for 34 is positioned in contact with the an engagement portion 44B of the partial engagement cam 44 and the shift fork actuator portion 40 is disposed below the first and second gear fork 34. In a fifth position P5, the intermediate lever 38 is manipulated so that the reverse idler gear actuator portion 42 is engaged with the a reverse shaft or member 28. As the intermediate lever 38 translates from the fourth position P4 to the fifth position P5, the cam follower portion 48 engages the partial engagement cam 44, the third and fourth gear shift fork 34 translates laterally to engage the third and fourth gear synchronizer with the third gear, and thus the output shaft 14 to reduce the speed of the input shaft 12 prior to the meshing of the reverse idler gear with the output shaft 14 which is approximately a first gear ratio thus making the synchronization of the reverse idler gear with the output shaft 14 smoother by avoiding gear clash from high speed synchronization.

The description of the disclosure is merely exemplary in nature and variations that do not depart from the gist of the disclosure are intended to be within the scope of the disclosure. Such variations are not to be regarded as a departure from the spirit and scope of the disclosure.

We claim:

1. A transmission having a plurality of forward gear ratios and at least one reverse gear ratio, the transmission comprising:
an input member selectively connected to an engine output;
an output member connected to a vehicle drive shaft;
an idler gear rotatably supported by an idler member, and wherein the idler gear is selectively translated axially to mesh with each of a first gear and a second gear, the first gear is fixed for common rotation with the input member, and the second gear is fixed for common rotation with the output member to achieve the reverse gear ratio between the input and output members;
a planar gear set having a third gear in mesh with a fourth gear, the third gear rotatably supported by the output member and the fourth gear coupled for common rotation with the input member, and wherein the third gear is selectively coupled to the output member through axial movement of a synchronizer to achieve one of the plurality of forward gear ratios between the input and output members;
a first shift linkage member having a synchronizer portion and a fork portion, and wherein the synchronizer portion is engaged for common axial movement with the synchronizer;
an intermediate lever member having a shift linkage portion, a reverse idler gear portion, and a partial engagement cam portion, and wherein the intermediate lever member is selectively translated in an axial direction and a rotational direction; and
wherein the partial engagement cam portion of the intermediate lever member contacts and urges the fork portion of the shift linkage member to partially engage the synchronizer and the output member with the third gear.

2. The transmission of claim 1 wherein the cam portion of the intermediate lever member contacts the fork portion of the shift linkage member prior to the reverse idler gear portion of the intermediate lever member rotates and engages the idler member to mesh the reverse idler gear with the first and second gears.

3. The transmission of claim 2 wherein the planar gear set achieves an intermediate gear ratio when the third gear is engaged for common rotation with the input member.

4. The transmission of claim 3 wherein the planar gear set achieves one of a third and fourth gear ratio when the third gear is engaged for common rotation with the input member.

5. The transmission of claim 1 wherein the shift linkage includes a cam contact portion that extends from the fork portion to contact the cam portion of the intermediate lever member.

6. The transmission of claim 5 wherein the cam contact portion includes a resilient ball mechanism to contact the cam portion of the intermediate lever member.

7. The transmission of claim 6 where the cam portion of the intermediate lever member includes a partial engagement profile that prevents synchronizer clash with the third gear.

8. The transmission of claim 7 wherein the transmission includes a second shift linkage member having an idler gear fork and an elongated member, and wherein the idler gear fork is engaged for common axial movement with the idler gear, the elongated member is fixed to the idler gear fork, and the elongated member includes a notch that is selectively engaged by the reverse idler gear portion of the intermediate lever member.

9. A manual transmission having a plurality of forward gear ratios and at least one reverse gear ratio, the transmission comprising:
an input member selectively connected to an engine through a clutch;
an output member connected to a vehicle drive shaft;
an idler gear rotatably supported by an idler member, and wherein the idler gear is selectively translated axially to mesh with each of a first gear and a second gear, the first gear is fixed for common rotation with the input member, and the second gear is fixed for common rotation with the output member to achieve the reverse gear ratio between the input and output members;
a planar gear set having a third gear in mesh with a fourth, the third gear rotatably supported by the output member and the fourth gear coupled for common rotation with the input member, and wherein the third gear is selectively coupled to the output member through axial movement of a synchronizer to achieve one of a third and fourth of the plurality of forward gear ratios between the input and output members;
a first shift linkage member having a synchronizer portion and a fork portion, and wherein the synchronizer portion is engaged for common axial movement with the synchronizer;
an intermediate lever member having a shift linkage portion, a reverse idler gear portion, and a partial engagement cam portion, and wherein the intermediate lever member is selectively translated in an axial direction and a rotational direction; and
wherein the partial engagement cam portion of the intermediate lever member contacts and urges the fork portion of the shift linkage member to partially engage the synchronizer and the output member with the third gear prior to the reverse idler gear portion of the intermediate lever member rotates and engages the idler member to mesh the reverse idler gear with the first and second gears.

10. The transmission of claim 9 wherein the shift linkage includes a cam contact portion that extends from the fork portion to contact the cam portion of the intermediate lever member.

11. The transmission of claim 10 wherein the cam contact portion includes a resilient ball mechanism to contact the cam portion of the intermediate lever member.

12. The transmission of claim 11 where the cam portion of the intermediate lever member includes a partial engagement profile that prevents synchronizer clash with the third gear.

13. The transmission of claim 12 wherein the transmission includes a second shift linkage member having an idler gear fork and an elongated member, and wherein the idler gear fork is engaged for common axial movement with the idler gear, the elongated member is fixed to the idler gear fork, and the elongated member includes a notch that is selectively engaged by the reverse idler gear portion of the intermediate lever member.

14. A manual transmission having a plurality of forward gear ratios and at least one reverse gear ratio, the transmission comprising:
an input member selectively connected to an engine through a clutch;
an output member connected to a vehicle drive shaft;
an idler gear rotatably supported by an idler member, and wherein the idler gear is selectively translated axially to mesh with each of a first gear and a second gear, the first gear is fixed for common rotation with the input member, and the second gear is fixed for common rotation with the output member to achieve the reverse gear ratio between the input and output members;
a planar gear set having a third gear in mesh with a fourth gear, the third gear rotatably supported by the output member and the fourth gear coupled for common rotation with the input member, and wherein the third gear is selectively coupled to the output member through axial movement of a synchronizer to achieve one of the plurality of forward gear ratios between the input and output members;
a first shift linkage member having a synchronizer portion, a fork portion, and a cam contact portion, and wherein the synchronizer portion is engaged for common axial movement with the synchronizer and the cam contact portion extends from the fork portion;
an intermediate lever member having a shift linkage portion, a reverse idler gear portion, and a partial engagement cam portion, and wherein the intermediate lever member is selectively translated in an axial direction and a rotational direction; and
wherein the partial engagement cam portion of the intermediate lever member contacts the cam contact portion of the shift linkage member to partially engage the synchronizer and the output member with the third gear.

15. The transmission of claim 14 wherein the cam portion of the intermediate lever member contacts the fork portion of the shift linkage member prior to the reverse idler gear portion of the intermediate lever member rotates and engages the idler member to mesh the reverse idler gear with the first and second gears.

16. The transmission of claim 15 wherein the planar gear set achieves an intermediate gear ratio when the third gear is engaged for common rotation with the input member.

17. The transmission of claim 16 wherein the planar gear set achieves one of a third and fourth gear ratio when the third gear is engaged for common rotation with the input member.

18. The transmission of claim 14 wherein the cam contact portion includes a resilient ball mechanism to contact the cam portion of the intermediate lever member.

19. The transmission of claim 18 where the cam portion of the intermediate lever member includes a partial engagement profile that prevents synchronizer clash with the third gear.

20. The transmission of claim 19 wherein the transmission includes a second shift linkage member having an idler gear fork and an elongated member, and wherein the idler gear fork is engaged for common axial movement with the idler gear, the elongated member is fixed to the idler gear fork, and the elongated member includes a notch that is selectively engaged by the reverse idler gear portion of the intermediate lever member.
